(19) United States
(12) Patent Application Publication
(10) Pub. No.: US 2005/0192942 A1
(43) Pub. Date: Sep. 1, 2005

(54) Accelerated query refinement by instant estimation of results

(76) Inventors: Stefan Biedenstein, Nussloch (DE); Jens-Peter Dittrich, Heidelberg (DE); Erich Marschall, Nussloch (DE); Olaf Meincke, Heidelberg (DE); Klaus Nagel, Heidelberg (DE); Guenter Radestock, Karlsruhe (DE); Andrew Ross, Altrip (DE); Stefan Unnebrink, Heidelberg (DE)

Correspondence Address: FISH & RICHARDSON, P.C., PO BOX 1022, MINNEAPOLIS, MN, 55440-1022, US

(21) Appl. No.: 10/789,813

(22) Filed: Feb. 27, 2004

(51) Int. Cl. G06F 17/30

(52) U.S. Cl. 707/3

(57) ABSTRACT

Methods and apparatus, including computer systems and program products, for processing queries for which a solution requires that an information management system perform logical operations on a data repository. In general, in one aspect, the techniques feature a method of executing queries on a data repository. That method includes receiving a query, adapted for execution on a data set in the data repository; defining a sample of the data set, where the sample is a subset of the data set; executing the query on the sample; generating an estimate of a result of the execution of the query on the sample; and providing the estimate to a user interface. The method may further include defining an Nth sample, such that the Nth sample is larger than an (N−1) th sample, and generating an Nth estimate of the result based on the execution of the query on the Nth sample.

### BACKGROUND

The following description relates to systems and methods of processing queries for which a solution requires that an information management system perform logical operations on a data repository.

An information management system may include an information retrieval system and/or a database management system. An information management system can include a computer system and a data repository, including one or more databases, each of which is a collection of tables representing classes of physical or conceptual objects. Each object is represented by a record, which is also known as a row. The information contained in a record may include multiple attributes. Each attribute may correspond to a piece of information. For example, in a business context, there may exist a database of customer information. In such a database, each record may correspond to a customer and the attributes for each record may include information such as the name of the customer, the address of the customer, and the phone number of the customer.

There are different ways to view the data in an information management system. One type of view is known as a multidimensional view and is typically implemented as either what is known as a Star Schema or a Snowflake Schema. In a multidimensional view, each fact table has several dimensions such that each attribute of a table represents a dimension. Relational databases can be used to generate a multidimensional view of data. One use case for accessing data and performing operations on a database, when using a multidimensional view, is known as online analytical processing (OLAP).

There are many business or other software application-driven user operations that process data in response to a query. Such operations are performed when a user of an information management system enters a query and, in response to that query, the system processes data based on the criteria specified in the query. In the context of an OLAP system, OLAP navigation is a recursive process, where the user can navigate by using the result of a previous query to create a new query, and so on, as often as the user chooses. For example, in a graphical user interface environment incorporating a mouse to facilitate user input, a query may be submitted when a user drags chosen key figures and characteristics from a displayed list, drops the key figures and characteristics onto display dimensions, and submits the query to trigger the computation of a result. The user may further navigate in an OLAP system by modifying the query based on the initial result and submitting the modified query to trigger the computation of a second result. The result may include one or more rows from the database.

Processing queries via an information management system may be time-consuming, as a database may store large volumes of data which may need to be processed each time a query is processed. In a business or consumer context, response times of more than a few seconds for typical user queries tend to be unacceptable.

In order for a user to execute a query that retrieves a result of sufficient quality for the purposes of a user, the user may need to refine the criteria in the query and then resubmit the query. However, a user who submits a query may be unable to estimate the number of rows in the result. The user may have expected a small amount of rows in a result and may be unable to benefit from a result containing several thousand rows, or alternatively a user may be unable to benefit from a result with too few rows. In either case, the user may modify and resubmit the query several times in an attempt to optimize the size of the result. All this increases the time required to answer the query and can be frustrating for the user.

### SUMMARY

This document relates to a system and method of processing queries for which a solution requires that an information management system perform logical operations on a data repository.

In one general aspect, the techniques feature a method of executing queries on a data repository. That method includes receiving a query, adapted for execution on a data set in the data repository; defining a sample of the data set, where the sample is a subset of the data set; executing the query on the sample; generating an estimate of a result of the execution of the query on the sample; and providing the estimate to a user interface.

Implementations may include one or more of the following features. The query may include criteria to provide the result of the execution of the query. Providing the estimate may include displaying a representation of the estimate. The method may further include defining an Nth sample of the data set, where the Nth sample is larger than an (N−1) th sample; executing the query on the Nth sample; generating an Nth estimate of the result based on the execution of the query on the Nth sample; and providing the Nth estimate to a user interface. In that case, the Nth sample of the data set may be defined if the query is neither modified nor canceled after a preset time; the Nth sample may be defined to be larger than the (N−1) th sample by a factor Y; and/or, the method may further include, if the Nth sample is greater than or equal to a size Z, executing the query on the data set to generate the result, and providing the result to the user interface.

In an other aspect, an information management system includes a data repository, which is configured to store a data set; and a program for executing queries on the data repository. In that case the program is operative to receive a query, adapted for execution on a data set in the data repository; define a sample of the data set, where the sample is a subset of the data set; execute the query on the sample; generate an estimate of a result of the execution of the query on the sample; and provide the estimate to a user interface.

Implementations may include one or more of the following features. The query may include criteria to provide the result of the execution of the query. The operation of providing the estimate of the result may include displaying a representation of the estimate. The program may be further operative to define an Nth sample of the data set, where the Nth sample is larger than an (N−1) th sample; execute the query on the Nth sample; generate an Nth estimate of the result based on the query of the Nth sample; and provide the Nth estimate to a user interface. In that case, the Nth sample of the data set may be defined if the query is neither modified nor canceled after a preset time; the Nth sample may be defined to be larger than the (N−1) th sample by a factor Y; and/or, the program may be further operative to, if the Nth sample is greater than or equal to a size Z, execute the query on the data set to generate the result, and provide the result of the query execution to the user interface.

The system and method of executing queries on data and related mechanisms and/or techniques described here may provide one or more of the following advantages. A method of executing queries may provide a preliminary estimate of the size or other attribute of a result based on a sample of relevant data from the database. The method may either provide these estimates automatically (i.e. as soon as a user enters criteria for a query, thus instantaneous) or in response to a user action. An estimate of the total number of records in a result may benefit a user who wishes to experiment with different query criteria because a response based on a sample tends to be faster than a response based on the entire data set. Thus, the user can advantageously adjust the query before the query is submitted in order to return an appropriately sized result from the first submission. The estimation algorithm may progressively update the estimate automatically based on a continually growing sample size until a threshold is reached. This may advantageously provide a user with an increasingly accurate estimate, as an estimate tends to be more accurate when the sample size is increased.

Other than or in addition to the instant display of the estimated size of the result, estimated values for other values that may be significant to a user and are based on the sample, such as a value “total sum” or “amount” in the context of an OLAP query may be displayed instantaneously.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a flowchart of a process of configuring settings prior to executing a query.

FIG. 2 is a flowchart of a method of executing a query.

Like reference numerals and designations in the drawings indicate like elements.

### DETAILED DESCRIPTION

The systems and techniques described here relate to methods and systems for executing queries on data, including estimation of results based on a sample.

A query may be executed on a data repository, hereinafter called a database, when a user submits a query. A query includes filter criteria for selecting data from the database, also known as selection criteria. In an example query execution using the example customer database discussed above, the criteria may be “all customers with an address in California.” In a multidimensional view of data, criteria may relate to several attributes. For example, in a query on the example customer database, the criteria for an OLAP query may be “all customers with an address in California that purchased product A or product B between May 2000 and June 2000.”

In response to a query, a result may be generated. The result represents the data in the database that matches the criteria in the query. The result may be provided to a user interface and/or displayed on a display device.

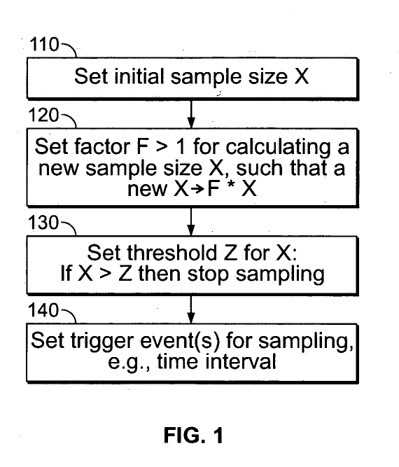

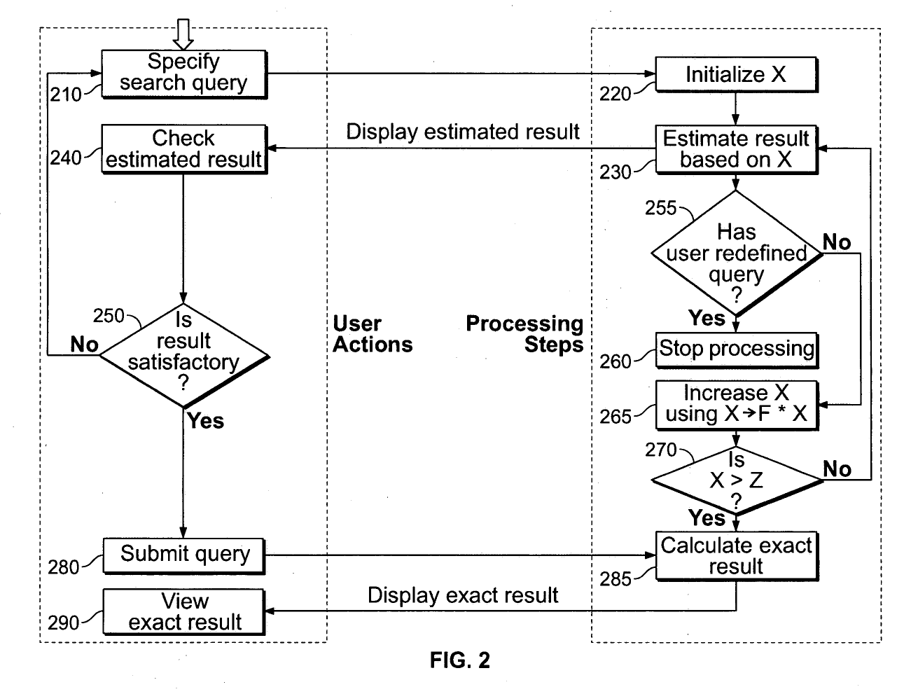

FIG. 1 is a flowchart of a process of configuring settings prior to specifying a query. The settings would typically be made during installation of software that implements a method of executing a query, such as the method of FIG. 2. Typically, once the settings are configured, the settings would only be modified in certain circumstances, such as, for example, a significant change in the amount of data held in the database. In alternative implementations, the software may be delivered with default settings that need not be changed during installation. Also, in different implementations, the order of 110, 120, 130, and 140 may be varied freely, and additional or different settings may be configured.

An initial sample size X is specified at 110. In principle, the initial sample size may be any nonzero fraction of the size of the entire set of relevant records, so long as it is less than 100%; but, in order to provide the desired acceleration of the display of an estimate, the initial sample size should be much smaller than the entire relevant data set. Thus, the initial sample size X may be specified as, for example, 1% of the size of the entire set of database records that are relevant to answering the query.

At 120 a factor F, for calculating a new sample size from the size of the previous sample, is specified. The factor F is used in accordance with the formula: new sample size equals F multiplied by the previous sample size. This formula is merely illustrative and in alternative implementations the formula may be replaced by any other formula that increases the sample size.

A threshold Z, which corresponds to the sample size X, is specified at 130. As soon as the new sample size, calculated by the formula of 120, is greater than the threshold Z, estimates need not be generated and the exact result may be calculated from the entire set of relevant records.

Optionally, one or more trigger events for the initiation of a sampling calculation are specified at 140. Such an event may be, for example, the lapse of a preset interval of time, such as 500 milliseconds, or it may be a user action, such as clicking on a button in a graphical user interface. If trigger events are not set, the software may have default settings such that each new sampling calculation is triggered by the completion of the previous sampling calculation, as shown in the processing loop including 230, 255, 265, and 270 of FIG. 2.

FIG. 2 is a flowchart of a method of executing a query. User actions are shown on the left side of the flowchart and system-processing actions are shown on the right side. The system-processing actions may be performed by an information management system. The sequence of the processes of FIG. 2 is illustrative and the details may vary in alternative implementations. For example, in one implementation, user input may be required to trigger calculation of more accurate estimates based on larger sample sizes. Also, in alternative implementations, additional and/or different processes and sub-processes can be used instead. Similarly, the processes need not be performed in the order depicted.

At 210 a user specifies a query. Specifying the query includes specifying criteria based on the data schema of the data in the database. The number and types of criteria that may be used depends on the query language supported by a particular information management system. A query language is a specification for executing queries on a database, such as, for example, Structured Query Language (SQL).

At 220 an initial sample size X is defined. A sample is a randomly chosen subset of the relevant data set. The relevant data set is the entire data set with respect to which the query is to be evaluated, that is to say, the domain of objects such as documents or records over which the exact execution is to be performed. The size of the entire set of relevant records can easily be determined, by any of a number of techniques, on the basis of the database and the criteria in the query. In alternative implementations the sample may be computed by any of a number of selection techniques.

At 230 the query is executed on the sample using the specified criteria. Any number of query processing techniques may be used to compute the result of the query on the sample, which is used to generate an estimate of a result that would be generated were the query executed on the entire data set. The estimate is displayed for the user.

At 240 the user checks the displayed estimate based on the initial sample of the data. The estimate may be, for example, a total number of records that would be expected to match the query criteria if a query were executed on the entire data set. In accordance with the customer database example, the sample size may be 1% and, according to that sample, 10 records may match the criteria specified, thus, 1000 records are estimated to occur if a query were executed (10 records×1/1%=1000 estimated records as a result). In alternative implementations, any number of techniques may be used to estimate the result based on the sample. Also, in alternative implementations, the estimate need not be the total number of records, and may be some other useful metric for estimating the result of a query on the entire data set.

At 250 the user may decide, on the basis of the estimated result, to change the query and thus start the sampling cycle anew (i.e. 210, 220, 230, 240, and 250). If the user so decides, the previous sampling process is terminated (i.e. canceled).

At 255 a determination is made as to whether the user has decided to reformulate the query, as decided at 250. If the user has so decided, the sampling process is terminated at 260 and a new sampling process is started on the basis of the reformulated query.

At 265 a new sample size is calculated in accordance with a formula, such as the formula specified at 130. The calculation of a new sample size may be triggered by the trigger event or events that may have been specified at 140.

At 270 the new value for the sample size X is checked against a threshold Z, such as the threshold Z that was specified at 130. If the new value of X is greater than Z, the sampling procedure is terminated and a result is generated based on an execution of the query on the entire data set. If the new value of X is not greater than Z, the estimate is calculated and displayed as specified at 230.

At 280 the user may submit a query so that a result is generated. If the user does so, the user is no longer provided estimated results.

At 285 the information management system generates the result that was requested at 280. When the result is available, the system forwards the result to the user interface.

At 290 the user interface presents the result to the user. The user interface may be any type of interface, including a graphical user interface or a command line interface.

Although, in FIG. 2, estimates of the size of the result continue to be generated until the sample size X is equal to or greater than the threshold Z, a query may be executed on the data set in response to any number of events. For example, a user of a system that incorporates an implementation of the techniques and/or methods described in this document may be content with the estimate of the result and may proceed to submit the query after the first estimate of the result is generated. In alternative scenarios, the query need not be executed. For example, in one scenario, a user may decide, after an estimate is generated, that the estimated number of records returned based on the criteria is too vast. In that case, the user may modify the criteria in an attempt to reduce the expected number of records that would be returned if a query were to be executed on the data set. The estimates of the result may be triggered either automatically or by a user action, and may or may not continue to be refined automatically based on increased sample sizes, until a result is generated for the entire data set. However, depending on the implementation, retrieval of the actual rows in the result may require one or more additional user actions. For example, a screen display may be generated that includes the top ten rows with hyperlinks that trigger retrieval of further pages of rows.

Although a few embodiments have been described in detail above, other modifications are possible. For example, in alternative implementations the estimate of the result need not be progressively updated. Other embodiments may be within the scope of the following claims.

1. A method of executing queries on a data repository, the method comprising:
receiving a query, adapted for execution on a data set in the data repository;
defining a sample of the data set, wherein the sample is a subset of the data set;
executing the query on the sample;
generating an estimate of a result of the execution of the query on the sample; and
providing the estimate to a user interface.

2. A method of executing a query in accordance with claim 1, wherein the query includes criteria to provide the result of the execution of the query.

3. A method of executing a query in accordance with claim 1, wherein providing the estimate comprises displaying a representation of the estimate.

4. A method of executing a query in accordance with claim 1, the method further comprising:
defining an Nth sample of the data set, wherein the Nth sample is larger than an (N−1) th sample;
executing the query on the Nth sample;
generating an Nth estimate of the result based on the execution of the query on the Nth sample; and
providing the Nth estimate to a user interface.

5. A method of executing a query in accordance with claim 4, wherein the Nth sample of the data set is defined if the query is neither modified nor canceled after a preset time.

6. A method of executing a query in accordance with claim 4, wherein the Nth sample is defined to be larger than the (N−1) th sample by a factor Y.

7. A method of executing a query in accordance with claim 4, the method further comprising:
if the Nth sample is greater than or equal to a size Z,
executing the query on the data set to generate the result, and
providing the result to the user interface.

8. An information management system, the system comprising:
a data repository, wherein the data repository is configured to store a data set; and
a program for executing queries on the data repository, wherein the program is operative to:
receive a query, adapted for execution on a data set in the data repository;
define a sample of the data set, wherein the sample is a subset of the data set;
execute the query on the sample;
generate an estimate of a result of the execution of the query on the sample; and
provide the estimate to a user interface.

9. An information management system in accordance with claim 8, wherein the query includes criteria to provide the result of the execution of the query.

10. An information management system in accordance with claim 8, wherein the operation of providing the estimate of the result comprises displaying a representation of the estimate.

11. An information management system in accordance with claim 8, wherein the program is further operative to:
define an Nth sample of the data set, wherein the Nth sample is larger than an (N−1) th sample;
execute the query on the Nth sample;
generate an Nth estimate of the result based on the query of the Nth sample; and
provide the Nth estimate to a user interface.

12. An information management system in accordance with claim 11, wherein the Nth sample of the data set is defined if the query is neither modified nor canceled after a preset time.

13. An information management system in accordance with claim 11, wherein the Nth sample is defined to be larger than the (N−1) th sample by a factor Y.

14. An information management system in accordance with claim 11, wherein the program is further operative to:
if the Nth sample is greater than or equal to a size Z,
execute the query on the data set to generate the result, and
provide the result of the query execution to the user interface.
